(19) United States
(12) Patent Application Publication
(10) Pub. No.: US 2025/0080681 A1
(43) Pub. Date: Mar. 6, 2025

(54) READING SYSTEM, NON-TRANSITORY COMPUTER READABLE MEDIUM, AND READING METHOD

(71) Applicant: FUJIFILM Business Innovation Corp., Tokyo (JP)

(72) Inventor: Daiki KIMIZUKA, Kanagawa (JP)

(73) Assignee: FUJIFILM Business Innovation Corp., Tokyo (JP)

(21) Appl. No.: 18/582,564

(22) Filed: Feb. 20, 2024

(30) Foreign Application Priority Data
Aug. 29, 2023 (JP) 2023-139331

(51) Int. Cl. H04N 1/409; H04N 1/00

(52) U.S. Cl. CPC H04N 1/4092; H04N 1/00798

(57) ABSTRACT

A reading system includes: a reader that generates a read image by reading reflected light reflected from a target, the reflected light being received by a light receiving part after emitted light emitted from a light source is radiated onto the target; and a processor configured to: receive read data obtained by the reader by reading white reference; and in response to a difference between the read data and reference data exceeding a set value set in advance, execute an edge enhancement process with a spatial filter on the read image and output, as a processed image, the read image that has undergone the edge enhancement process.

### CROSS-REFERENCE TO RELATED APPLICATIONS

This application is based on and claims priority under 35 USC 119 from Japanese Patent Application No. 2023-139331 filed Aug. 29, 2023.

### BACKGROUND

### (i) Technical Field

The present disclosure relates to a reading system, a non-transitory computer readable medium, and a reading method.

### (ii) Related Art

Japanese Unexamined Patent Application Publication No. 2012-39506 discloses technology related to an image processing apparatus, and an image processing system, and a program. In this related art, in a function such as image copying, an original image signal output from a charge coupled device (CCD) image sensor is amplified by an amplification unit with an amplification factor set on the basis of image signal reference strength. In contrast, an image signal used in a paper fingerprint processing unit is not amplified by the amplification unit and is generated on the basis of the original image signal output from the CCD image sensor. At that time, a controller controls a motor driving circuit to decrease the speed in a sub-scanning direction in document reading and increases an exposure value at the CCD image sensor by an amount corresponding to the amplification factor to raise the strength of the original image signal to the reference strength.

### SUMMARY

Light emitted from a light source is reflected from a target such as a document, the reflected light is received by a light receiving part, and a read image of the target is generated. If a decrease in the amount of light due to light source deterioration over time causes a decrease in the amount of received light received by the light receiving part, the decrease causes an increase in a noise ratio, a decrease in the SN ratio of the read image, and then the deterioration of the image quality of the read image. However, in a case where deterioration of the image quality of the read image is reduced by decreasing the noise ratio and thus increasing the SN ratio, for example, a process for increasing output of the light source above a rated value or a process for decreasing the reading speed below normal is required.

Aspects of non-limiting embodiments of the present disclosure relate to reducing image quality deterioration without executing a process for relatively reducing noise as compared with a case where a read image is output as it is.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a reading system including: a reader that generates a read image by reading reflected light reflected from a target, the reflected light being received by a light receiving part after emitted light emitted from a light source is radiated onto the target; and a processor configured to: receive read data obtained by the reader by reading white reference; and in response to a difference between the read data and reference data exceeding a set value set in advance, execute an edge enhancement process with a spatial filter on the read image and output, as a processed image, the read image that has undergone the edge enhancement process.

### BRIEF DESCRIPTION OF THE DRAWINGS

An exemplary embodiment of the present disclosure will be described in detail based on the following figures, wherein:

FIG. 1 is a schematic perspective view illustrating an example configuration of an image forming apparatus according to an exemplary embodiment of the present disclosure;

FIG. 2 is a schematic cross-sectional view illustrating an example configuration of an image reader illustrated in FIG. 1;

FIG. 3 is a schematic cross-sectional view illustrating an example configuration of a back-side image reader illustrated in FIG. 1;

FIG. 4 is a block diagram illustrating an example configuration of an electrical system of the image forming apparatus illustrated in FIG. 1;

FIG. 5 is a block diagram illustrating an example configuration of an electrical system of the image reader illustrated in FIG. 1;

FIG. 6 is a block diagram illustrating an example functional configuration of the image reader illustrated in FIG. 1;

FIGS. 7A, 7B, and 7C are views for explaining an edge enhancement process;

FIG. 8 is a flowchart illustrating an example flow of the image processing of a read image read by the front-side image reader;

FIG. 9 is a flowchart illustrating an example flow of the image processing of a read image read by the back-side image reader;

FIG. 10 is an explanatory view for explaining a lookup table (LUT) used in the image processing of the read image read by the front-side image reader;

FIG. 11 is an explanatory graph for explaining a LUT used in the image processing of the read image read by the back-side image reader;

FIG. 12 is an explanatory graph for explaining experiment results for generating a LUT; and

FIG. 13 is an explanatory graph for explaining interpolation with the edge enhancement process to cope with worsening in noise.

### DETAILED DESCRIPTION

### Image Forming Apparatus

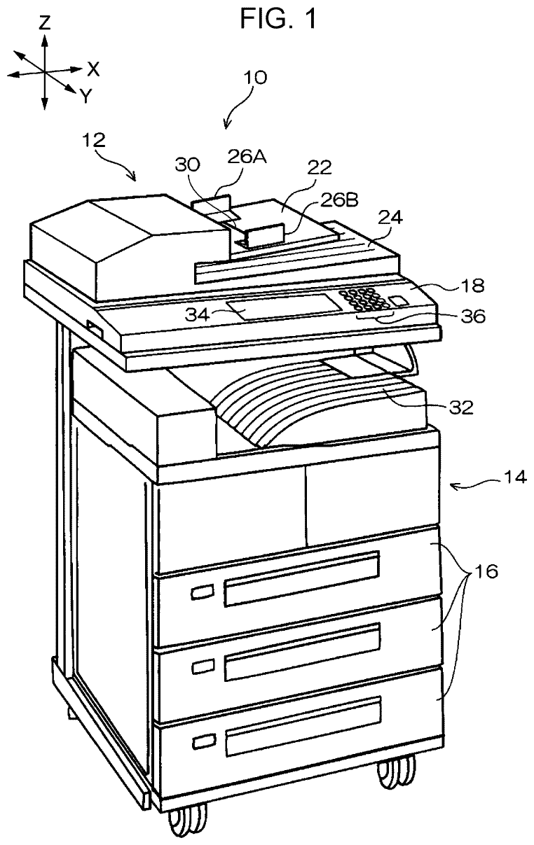

First, an image forming apparatus according to this exemplary embodiment will be described. A width direction, a height direction, and a depth direction of an image forming apparatus 10 illustrated in FIG. 1 are respectively an X direction, a Z direction, and a Y direction and represented by arrows X, Y, and Z.

### Schematic Configuration of Image Forming Apparatus

FIG. 1 is a schematic perspective view illustrating an example configuration of the image forming apparatus according to this exemplary embodiment. As illustrated in FIG. 1, the image forming apparatus 10 includes an image reader 12, an image forming part 14, a sheet supply part 16, an operation panel 18, and other components.

The image reader 12 serving as an example of a reading system includes a document tray 22 where a document sheet is placed, a document discharging part 24 from which the document sheet an image of which has been read is discharged, a transport mechanism that transports the document sheet placed in the document tray 22, an image reading sensor that optically reads an image of the document sheet or the like, a scanning mechanism for scanning the document sheet, and other components.

The image reader 12 of this exemplary embodiment is configured as a double-sided scanning device that reads a front-side image and a back-side image of a document sheet in one time transportation. Configuration in terms of appearance is herein described, and specific components of the transport mechanism, the image reading sensor, the scanning mechanism, and other components of the image reader 12 will be described later.

The document tray 22 is provided with pair of guides 26A and 26B on the upper surface of the document tray 22. When a document sheet placed in the document tray 22 is transported, the pair of guides 26A and 26B guide the document sheet. The pair of guides 26A and 26B are configured such that at least one of the pair of guides 26A and 26B is moved in the Y direction that is the width direction of the document sheet placed in the document tray 22. The pair of guides 26A and 26B are moved in accordance with the width of the document sheet placed in the document tray 22.

The image forming part 14 includes an image forming mechanism that forms an image on the sheet supplied from the sheet supply part 16, a discharging mechanism for discharging the sheet having the image formed thereon to a sheet discharging part 32, and other components. The image forming mechanism includes an image forming unit that forms an image, for example, by using an electrophotographic system, a fixing device, and other devices. The image forming unit includes a photoconductor drum, a charging device, an exposure device, a developing device, a transfer device, a cleaning device, and other components. With the configuration described above, the image forming part 14 forms an image on the sheet supplied from the sheet supply part 16 and discharges the sheet having the image formed thereon to the sheet discharging part 32.

The sheet supply part 16 includes a sheet container that contains sheets, a supply mechanism that supplies a sheet from the sheet container to the image forming part 14, and other components. The supply mechanism may include take-out rollers that take out a sheet from the sheet container, transport rollers, and other components. The sheet supply part 16 may include multiple sheet containers for each type or size of the sheets. With the configuration above, the sheet supply part 16 supplies a sheet to the image forming part 14.

The operation panel 18 includes a touch panel 34 for displaying various screens such as a setting screen and various buttons 36 such as a start button and a numeric key pad. With the configuration above, the operation panel 18 functions as a user interface (UI) that receives operation by a user and displays various pieces of information to the user.

### Configuration of Image Reader

The configuration of the image reader 12 will then be described.

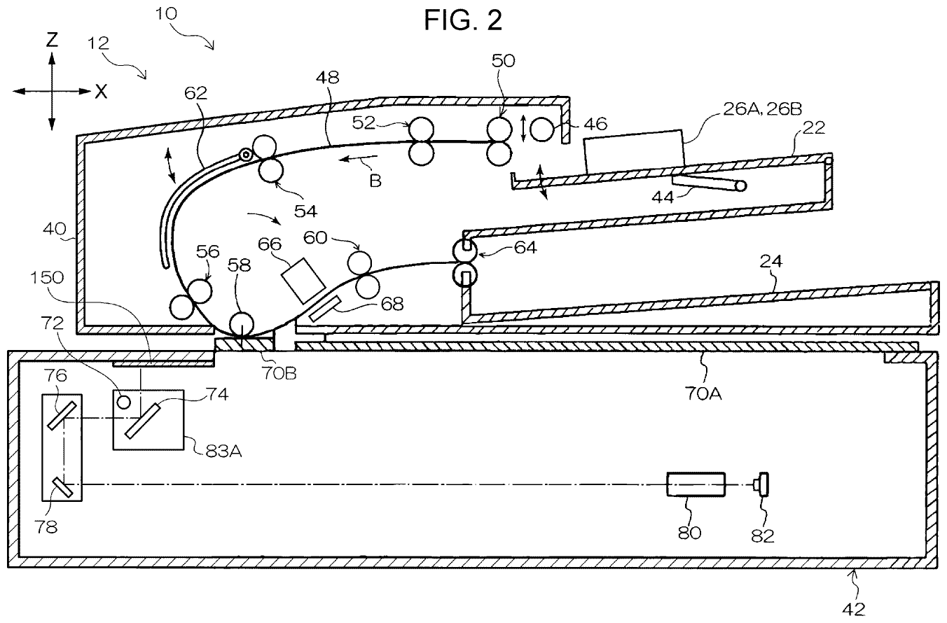

FIG. 2 is a schematic cross-sectional view illustrating an example configuration of the image reader 12 illustrated in FIG. 1. As previously mentioned, the image reader 12 is configured as the double-sided scanning device.

The image reader 12 includes a document transport part 40 that transports a document placed in the document tray 22, a front-side image reader 42 that reads an image on the front side of the document sheet (a front-side image), and a back-side image reader 66 that reads an image on the back side of the document sheet (back-side image). The back-side image reader 66 is provided in the document transport part 40. The back-side image reader 66 is provided downstream of the front-side image reader 42 in a direction of transporting a sheet.

The document transport part 40 includes a lifting mechanism 44 that lifts up and down the document tray 22, a take-in roller 46 that is in contact with the top of a stack of document sheets placed in the document tray 22 lifted up by the lifting mechanism 44 and that takes in the document sheets one by one, supply rollers 50 that supply a transport path 48 with each document sheet taken in by the take-in roller 46, various transport rollers 52, 54, 56, 58, and 60 that transport the document sheet further downstream in the transport direction along the transport path 48, and other components. The rotation axis of each roller extends in the Y direction orthogonal to the document-sheet transport direction.

The document transport part 40 also includes a guide mechanism 62 that moves with rotation around the fulcrum in accordance with the looped state of the transported document sheet and discharge rollers 64 that discharges the document sheet to the document discharging part 24. The looped state of the document sheet denotes that the transport path 48 for a document sheet is curved in such a manner as to form a loop and that the document sheet enters a state curved along the transport path 48.

The front-side image reader 42 serving as an example of a reader includes transparent first platen glass 70A, transparent second platen glass 70B, a first light source 72 that radiates illumination to the document sheet, reflection mirrors 74, 76, and 78 that cause the optical path of the reflected light reflected from the document sheet to be bent, a lens 80 that causes image formation from reflected light reflected from the reflection mirror 78, a first image reading sensor 82 disposed at an image forming position for the lens 80, and other components. The term “transparent” denotes that each of the aforementioned illumination and the reflected light is transmitted

As previously mentioned, the image reader 12 of this exemplary embodiment is configured as the double-sided scanning device that reads images on both of the front and back sides from the document sheet being transported by the document transport part 40. However, to read an image on one of the sides of the document sheet, an image on the side facing the first platen glass 70A on which the document sheet is placed may be read without using the document transport part 40.

The first platen glass 70A is disposed in a central portion of the upper surface of the front-side image reader 42 to read the image on one of the sides of the document sheet placed on the first platen glass 70A. A shielding member (not illustrated) for shielding the illumination and the reflected light is disposed on a peripheral portion of the upper surface of the front-side image reader 42, that is, around the first platen glass 70A.

In contrast, the second platen glass 70B is formed in the opening of the aforementioned shielding member (not illustrated) to read the front-side image of the document sheet being transported by the document transport part 40. The second platen glass 70B is thus provided in part of the peripheral portion of the upper surface of the front-side image reader 42. The second platen glass 70B is disposed in such a manner as to face the transport roller 58 of the document transport part 40. That is, the front-side image of the document sheet is read at a position where the transport roller 58 is disposed. Hereinafter, the position is referred to as a front-side-image reading position.

As the first light source 72, a light emitting diode (LED) array in which multiple LEDS are arranged in the Y direction orthogonal to the document-sheet transport direction is used in this exemplary embodiment. The first light source 72 and the reflection mirror 74 are installed on a carriage 83A, while the reflection mirrors 76 and 78 are installed on a carriage 83B. The carriages 83A and 83B are controlled by an image reading controller 92 (described later) and is moved in the Y direction. That is, each of the first light source 72 and the reflection mirrors 74, 76, and 78 is moved in the Y direction.

As the first image reading sensor 82 serving as an example of a light receiving part, a CCD line sensor in which multiple CCDs are arranged in the Y direction orthogonal to the document-sheet transport direction is used in this exemplary embodiment. That is, the first image reading sensor 82 serves as a light receiving part that is a reduced optical system.

A first white reference plate 150 is disposed on the left side of the front-side-image reading position in FIG. 2 in the X direction. The first white reference plate 150 is a plate having a uniform reflectivity in the Y direction serving as a main-scanning direction. The first white reference plate 150 is provided to be optically read by the first image reading sensor 82 and to thereby acquire image information for performing image processing such as shading correction and an edge enhancement process with a spatial filter.

The back-side image reader 66 serving as an example of the reader is disposed between the transport roller 58 and the transport rollers 60 of the document transport part 40. In this exemplary embodiment, as a second image reading sensor 100 (described later) of the back-side image reader 66, a contact image sensor (CIS) that reads an image in such a manner as to be in close contact with the document sheet is used. Accordingly, the back-side image reader 66 is disposed in such a manner as to face the back side of the document sheet transported along the transport path 48. That is, the back-side image of the document sheet is read at the position where the back-side image reader 66 is disposed. Hereinafter, the position is referred to as a back-side-image reading position.

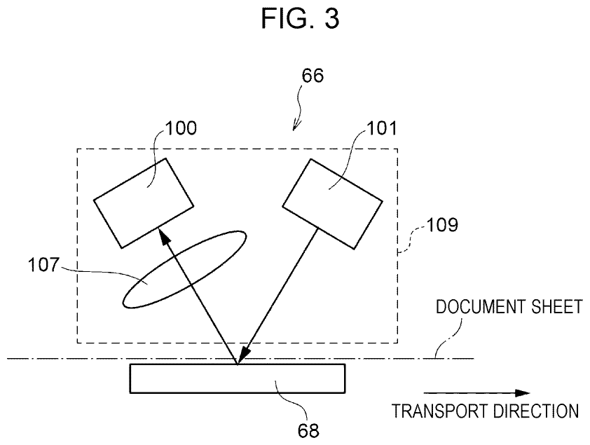

FIG. 3 is a schematic cross-sectional view illustrating an example configuration of the back-side image reader 66 illustrated in FIGS. 1 and 2. As illustrated in FIG. 3, the back-side image reader 66 includes a second light source 101, a lens 107, the second image reading sensor 100, and other components. The second light source 101 radiates illumination onto the back side of the document sheet transported by the document transport part 40 or onto a second white reference plate 68. The lens 107 causes image formation from the reflected light reflected from the back side of the document sheet or the second white reference plate 68. The second image reading sensor 100 is disposed at the image forming position for the lens 107. The second light source 101, the lens 107, and the second image reading sensor 100 are each fixed at a corresponding one of predetermined positions in a housing 109 and thus is contained in the housing 109.

As the second light source 101, a light source using a LED is used in this exemplary embodiment. As the second image reading sensor 100 serving as an example of the light receiving part, the CIS that reads an image in such a manner as to be in close contact with the document sheet is used in this exemplary embodiment as previously mentioned. The lens 107 is configured as a rod lens array having multiple rod lenses arranged in the Y direction orthogonal to the document-sheet transport direction.

The second white reference plate 68 is disposed in such a manner as to face the back-side image reader 66 across the transport path 48. The second white reference plate 68 is a plate having a uniform reflectivity in the Y direction serving as the main-scanning direction. The second white reference plate 68 is provided to be optically read by the second image reading sensor 100 and to thereby acquire image information for performing image processing such as shading correction and an edge enhancement process with a spatial filter.

### Operations of Image Reader

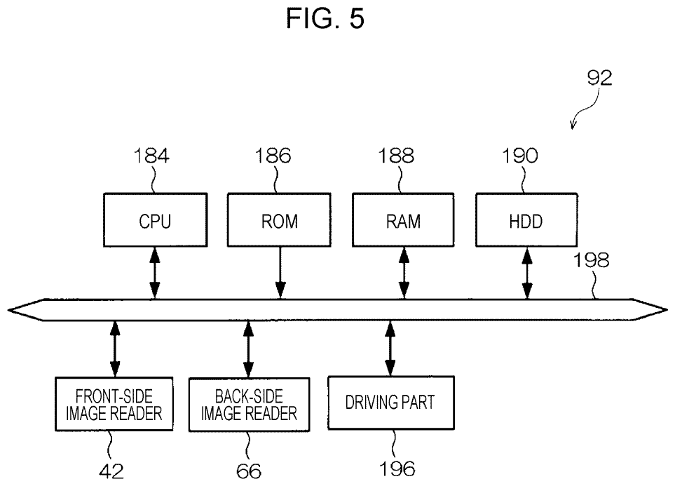

The operations of the image reader 12 will then be described. The image reader 12 is controlled by the image reading controller 92 (described later) and performs the following duplex reading operation. The various operations are driven by a driving part 196 (see FIG. 5) of the image reading controller 92. Each of the first light source 72 and the reflection mirrors 74, 76, and 78 is controlled by the image reading controller 92 to position the carriage 83A of the first light source 72 and the reflection mirror 74 immediately below the front-side-image reading position.

As illustrated in FIG. 2, after document sheets are placed in the document tray 22 with the front side facing up, the lifting mechanism 44 lifts up the document tray 22. In response to the document tray 22 being lifted up to a predetermined position and then stopped, the take-in roller 46 is brought into contact with the top of the stack of document sheets placed in the document tray 22 and takes in the document sheets one by one. After reaching the supply rollers 50, one of the document sheets is supplied to the transport path 48 by the supply rollers 50 to start the transportation of the document sheet. After reaching the transport rollers 52, the document sheet is transported downstream in the transport direction by the transport rollers 52.

After reaching the transport rollers 54, the document sheet is transported downstream in the transport direction by the transport rollers 54. The leading edge of the transported document sheet is thrust against the stopped transport rollers 56, and the document sheet enters the looped state in which the document sheet is curved along the transport path 48. In response to the document sheet entering the looped state, the guide mechanism 62 rotates in such a manner as to be opened to the outside around the fulcrum and guides the document sheet while keeping the looped state of the document sheet. The stopped transport rollers 56 start rotation in synchronization with the timing of image reading start.

After reaching the transport rollers 56, the document sheet is positioned by the transport rollers 56 and transported downstream in the transport direction. The document sheet is also transported to the front-side-image reading position where the transport roller 58 is disposed by the transport rollers 56. At the front-side-image reading position, the document sheet enters a state where the front side of the document sheet faces the second platen glass 70B. After reaching the transport roller 58, the document sheet is transported downstream in the transport direction with being pressed against the second platen glass 70B by the transport roller 58. The front-side image reader 42 reads the front-side image of the document sheet being transported with the second platen glass 70B interposed therebetween.

The document sheet having undergone the front-side image reading is transported downstream in the transport direction and then supplied to the back-side-image reading position where the back-side image reader 66 is disposed. At the back-side-image reading position, the document sheet enters a state where the back side of the document sheet faces the back-side image reader 66. The back-side image on the document sheet being transported is read by the back-side image reader 66. The document sheet having undergone the back-side image reading is transported downstream in the transport direction by the transport rollers 60. After reaching the discharge rollers 64, the document sheet is discharged to the document discharging part 24 by the discharge rollers 64.

If a document sheet is disposed on the upper surface of the first platen glass 70A as previously mentioned, an image on one side of the document sheet is read by the front-side image reader 42 in the following manner.

While the first light source 72 and the reflection mirrors 74, 76, and 78 are being moved to the right side of the Y direction, the illumination emitted from the first light source 72 is radiated to the document sheet. That is, one side of the document sheet is scanned with the illumination. The illumination is radiated to the document sheet after passing through the first platen glass 70A and then reflected from the document sheet. The reflected light passes through the first platen glass 70A, the optical path thereof is bent due to the reflection mirrors 74, 76, and 78, and the light enters the lens 80. The lens 80 causes the light incident on the lens 80 to be focused for image forming onto the first image reading sensor 82. The image on the one side of the document sheet is thereby read.

To read the first white reference plate 150 previously mentioned, the image reading controller 92 performs control to position the carriage 83A of the first light source 72 and the reflection mirror 74 immediately below the first white reference plate 150.

### Hardware Configuration

The electrical configuration of the image forming apparatus 10 will then be described.

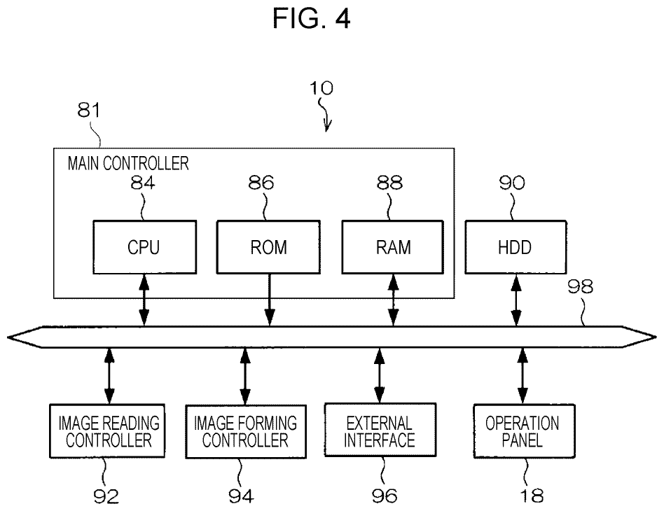

FIG. 4 is a block diagram illustrating an example configuration of an electrical system of the image forming apparatus 10 illustrated in FIG. 1. As illustrated in FIG. 4, the image forming apparatus 10 includes a main controller 81, a secondary storage 90 such as a hard disk drive (HDD) (also referred to as a HDD 90), the image reading controller 92, an image forming controller 94, an external interface 96, and the operation panel 18.

The main controller 81 is configured as a computer that performs overall apparatus control and various arithmetic operations. The main controller 81 includes a central processing unit (CPU) 84, a read only memory (ROM) 86, and a random access memory (RAM) 88. The CPU 84 reads out a program stored in the ROM 86 or the HDD 90 and runs the program by using the RAM 88 as a work area.

The image reading controller 92 is a control unit that is disposed in the image reader 12 and that performs the overall control of an image reading process. The image reading controller 92 performs control of the components of the image reader 12, various arithmetic operations, the image processing, and the like (described later).

The image forming controller 94 is a control unit that is disposed in the image forming part 14 and that performs the overall control of an image forming process. The image forming controller 94 is configured as a computer including a CPU, a ROM, a RAM, and other components (not illustrated) and performs control of the components of the image forming part 14 and various arithmetic operations.

The external interface 96 is an interface for communicating with an external apparatus via a wired or wireless communication network. For example, the external interface 96 functions as an interface for communicating with a computer connected to a network such as a local area network (LAN). The HDD 90 stores various pieces of data such as log data, various programs for overall control of the apparatus, and the like.

The CPU 84, the ROM 86, the RAM 88, the HDD 90, the image reading controller 92, the image forming controller 94, the external interface 96, and the operation panel 18 are electrically connected via a bus 98. The main controller 81 exchanges information with each of the HDD 90, the image reading controller 92, the image forming controller 94, and the operation panel 18 via the bus 98. The main controller 81 also exchanges information with the external apparatus via the bus 98 and the external interface 96.

The hardware configuration of the image reading controller 92 will then be described.

As illustrated in FIG. 5, the image reading controller 92 includes the front-side image reader 42, the back-side image reader 66, the driving part 196, a CPU 184 serving as an example of the processor, a ROM 186, a RAM 188, a HDD 190, and other components and performs control of the components of the image reader 12, various arithmetic operations, the image processing, and the like.

The CPU 184 serving as an example of the processor reads out a program stored in the ROM 186 or the HDD 190 and runs the program by using the RAM 188 as a work area. The front-side image reader 42, the back-side image reader 66, the driving part 196, the CPU 184, the ROM 186, the RAM 188, and the HDD 190 are electrically connected via a bus 198.

An example functional configuration of the image reading controller 92 will then be described.

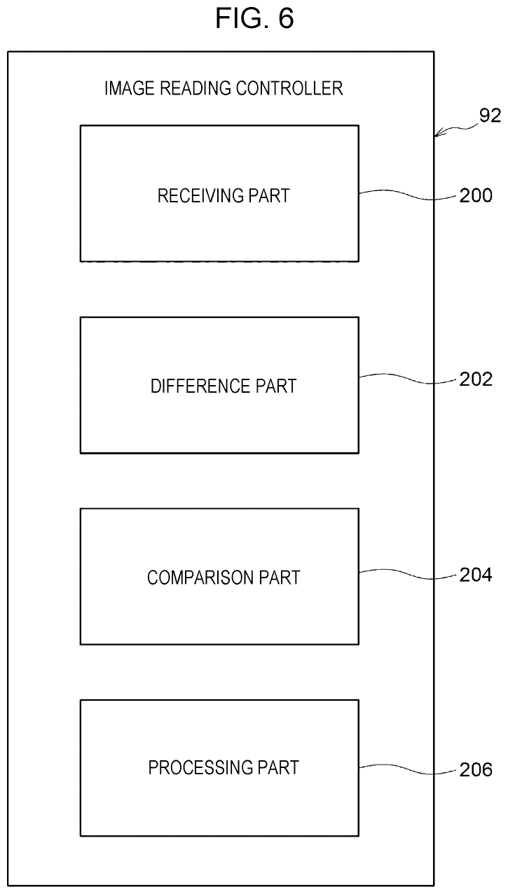

As illustrated in FIG. 6, the image reading controller 92 includes a receiving part 200, a difference part 202, a comparison part 204, and a processing part 206.

The receiving part 200 receives first read data and second read data (described later) obtained by reading the first white reference plate 150 and the second white reference plate 68. The difference part 202 finds a difference between the first read data received by the receiving part 200 and first reference data and a difference between the second read data and second reference data. The comparison part 204 compares the differences found by the difference part 202 with respective set values. If any of the differences found by the comparison part 204 exceeds the set value, the processing part 206 performs frequency filtering with a low pass filter on a corresponding one of the read images read by the front-side image reader 42 and the back-side image reader 66 and also executes an edge enhancement process with a spatial filter. The difference between the first read data and the first reference data and the difference between the second read data and the second reference data will be described later.

### Image Processing

The image processing performed by the image reading controller 92 on read images will then be described, the read images being obtained by reading a document by the front-side image reader 42 and the back-side image reader 66. The image processing is performed in such a manner that the CPU 184 (see FIG. 5) reads out a program stored in the ROM 186 or the HDD 190 (see FIG. 5), loads the program in the RAM 188 (see FIG. 5), and then runs the program.

An image output after the image processing in this process is referred to as a processed image. The image processing herein described is processing in which a read image undergoes the frequency filtering with the low pass filter and thereafter the edge enhancement process with the spatial filter; however, image processing other than this may be performed.

A setting operation for the image processing is performed at the time of startup in response to powering on and regularly after the powering on. The term “regularly” denotes, for example, every predetermined time elapsed since powering on or every predetermined number of read sheets.

The low pass filter in the image processing denotes a low pass filter with which low frequency components of spatial frequency components included in the image are left and high frequency components are removed. The frequency filtering with the low pass filter leads to a mild change in a section having drastic brightness change.

The processing with the spatial filter is processing in which a target pixel in the read image is converted on the basis of the target pixel and pixels therearound. The edge enhancement process with the spatial filter is processing in which an edge in the read image is enhanced.

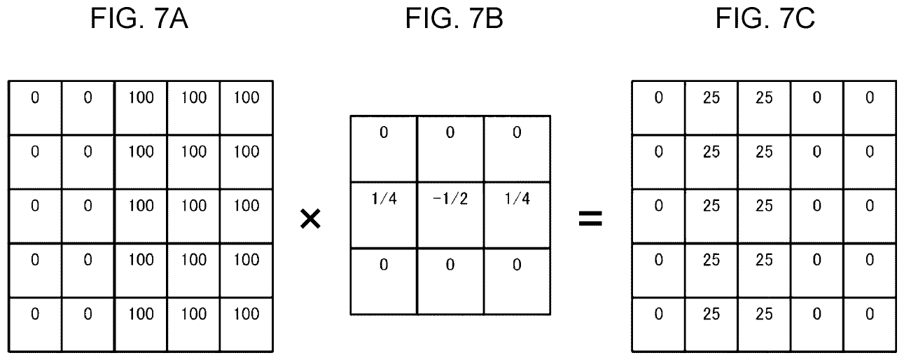

The edge enhancement process with the spatial filter will then be described briefly by using FIGS. 7A, 7B, and 7C.

FIG. 7A illustrates part of a read image. FIG. 7B illustrates an example of the spatial filter with which the edge enhancement process is executed. FIG. 7C illustrates a processed image resulting from the edge enhancement process executed with the spatial filter on the part of the read image in FIG. 7B. As illustrated in FIGS. 7A and 7C, pixels in three columns on the right side of the read image in FIG. 7A each have a value of 100, while pixels in the processed image after the processing in the first and second columns from the left in FIG. 7C each have a value of 25. It is thus understood that the edge is enhanced. In the calculation in the edge enhancement filter in FIGS. 7A to 7C, the absolute values of the calculation results are used.

### Front-Side Image Reader

First, image processing of a read image read by the front-side image reader 42 will be described.

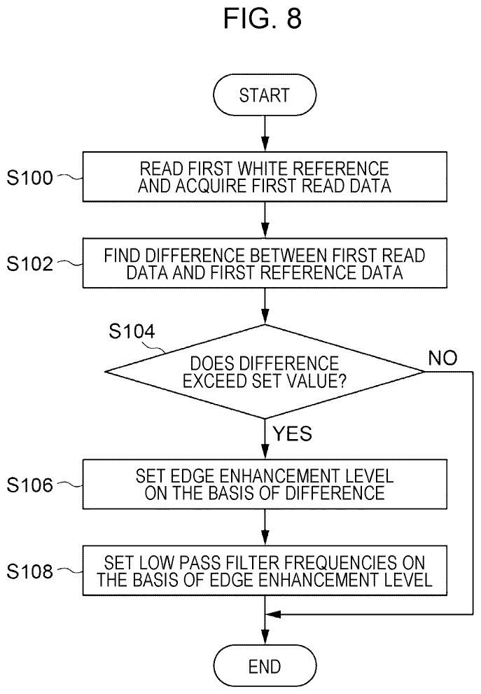

As illustrated in the flowchart in FIG. 8, in step S100, the CPU 184 (see FIG. 5) of the image reading controller 92 moves the carriage 83A of the first light source 72 and the reflection mirror 74 to position the carriage 83A immediately below the first white reference plate 150 (see FIG. 2). Radiated light emitted from the first light source 72 is radiated onto the first white reference plate 150, reflected light reflected from the first white reference plate 150 is received and read by the first image reading sensor 82 (see FIG. 2), and the first read data is acquired.

In step S102, the CPU 184 then finds a difference between the acquired first read data and the first reference data stored in the HDD 190 (see FIG. 5) or the like. The first read data and the second read data (described later) are specifically data regarding a white reference level. The white reference level is data for standardizing the maximum output level in an input range for the image reader 12.

In step S104, the CPU 184 then determines whether the difference between the first read data and the first reference data exceeds a set value set in advance. If the difference does not exceed the set value set in advance (No), that is, if the difference is lower than or equal to the set value, the processing is terminated. In this case, the read image is output as it is without performing the image processing described herein. If the difference exceeds the set value set in advance (Yes), the processing proceeds to step S106.

In step S106, the CPU 184 then sets a level for the edge enhancement process in the image processing on the basis of the difference. How to set a level for the edge enhancement process on the basis of the difference will be described later.

In step S108, the CPU 184 then sets frequencies for the low pass filter on the basis of the level for the edge enhancement process. Specifically, the higher the level for the edge enhancement process is, the more the CPU 184 lowers the frequencies for the low pass filter.

The image processing for the passing through the low pass filter having the frequencies set therefor and the spatial filter having a setting of the level for the edge enhancement process is thereby set for the read image read by the front-side image reader 42. That is, the read image read by the front-side image reader 42 undergoes the image processing in which the frequency filtering with the low pass filter and thereafter the edge enhancement process with the spatial filter are performed, and the read image is output as a processed image.

### Back-side Image Reader

Image processing of a read image read by the back-side image reader 66 will then be described.

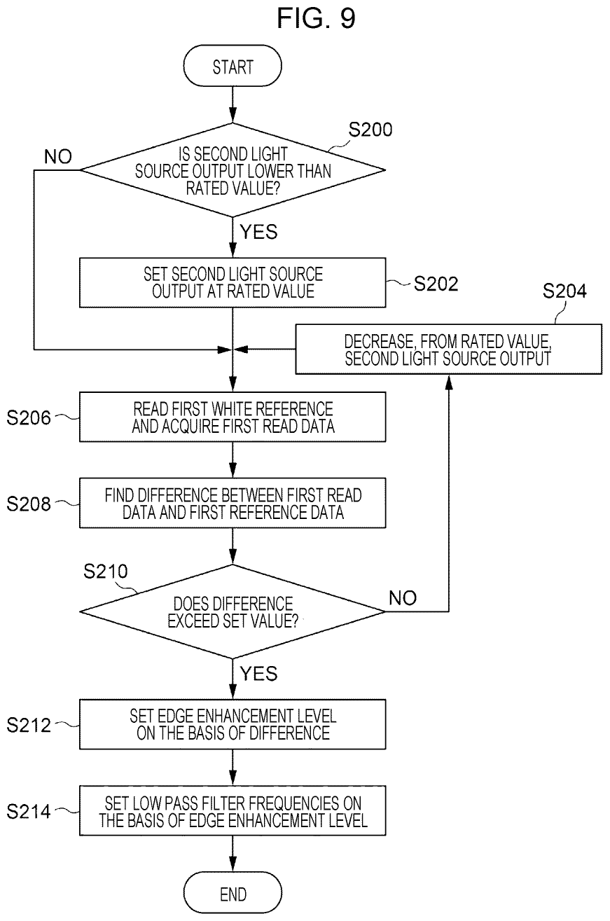

As illustrated in a flowchart in FIG. 9, in step S200, the CPU 184 (see FIG. 5) of the image reading controller 92 determines whether output of the second light source 101 (see FIG. 3) is lower than a rated value. In this exemplary embodiment, a value of current to be provided to the second light source 101 is output. If the output is lower than the rated value (Yes), the processing proceeds to step S202. If the output is the rated value (No), the processing proceeds to step S206. If the processing proceeds to step S202, the CPU 184 sets the output of the second light source 101 at the rated value.

In step S206, the CPU 184 then radiates radiated light emitted from the second light source 101 onto the second white reference plate 68. Reflected light reflected from the second white reference plate 68 is received and read by the second image reading sensor 100 (see FIG. 3), and the second read data is acquired.

In step S208, the CPU 184 then finds a difference between the acquired second read data and the second reference data stored in the HDD 190 (see FIG. 5) or the like.

In step S210, the CPU 184 then determines whether the difference between the second read data and the second reference data exceeds the set value set in advance. If the difference does not exceed the set value set in advance (No), that is, if the difference is lower than or equal to the set value, the processing proceeds to step S204. If the difference exceeds the set value set in advance (Yes), the processing proceeds to step S212.

In step S204, the CPU 184 decreases the output of the second light source 101 by an amount corresponding to a predetermined output value and returns to step S206. The CPU 184 repeats steps S206 to S210.

In step S210, if the difference again does not exceed the set value set in advance (No), the CPU 184 further decreases the output of the second light source 101 and returns to step S206. That is, the CPU 184 continues decreasing the output of the second light source 101 until the difference between the second read data and the second reference data exceeds the set value set in advance.

As previously mentioned, in step S210, if the difference exceeds the set value set in advance (Yes), the processing proceeds to step S212.

In step S212, the CPU 184 then sets a level for the edge enhancement process in the image processing on the basis of the difference. How to set a level for the edge enhancement process on the basis of the difference will be described later.

In step S214, the CPU 184 then sets frequencies for the low pass filter on the basis of the level for the edge enhancement process. Specifically, the higher the level for the edge enhancement process is, the more the CPU 184 lowers the frequencies for the low pass filter.

The image processing for the passing through the low pass filter having the frequencies set therefor and the spatial filter having a setting of the level for the edge enhancement process is thereby set for the read image read by the back-side image reader 66. That is, the read image read by the back-side image reader 66 undergoes the image processing in which the frequency filtering with the low pass filter and thereafter the edge enhancement process with the spatial filter are performed, and the read image is output as a processed image.

### Setting Level for Edge Enhancement Process

An example of setting for the edge enhancement process with the spatial filter will be then described.

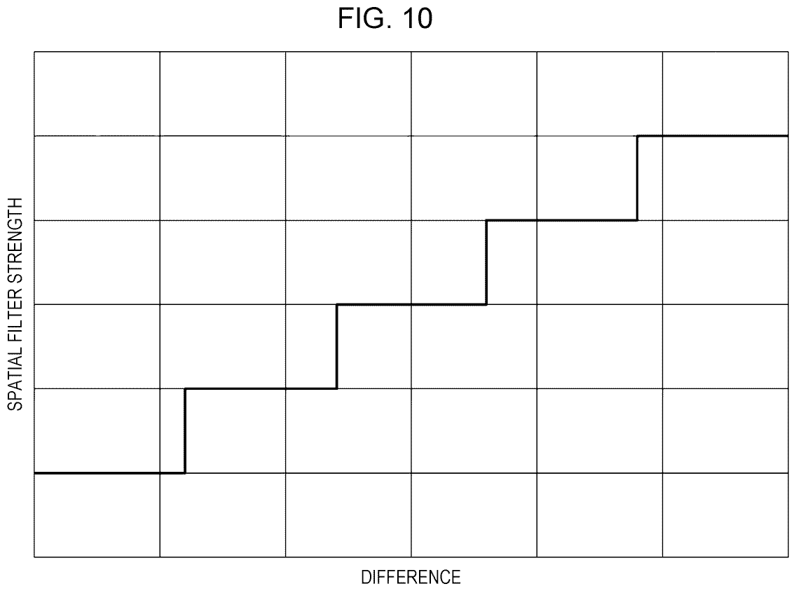

FIG. 10 is a view schematically illustrating a LUT used for the front-side image reader 42 stored in the HDD 190 or the like. In step S106 previously mentioned, the CPU 184 converts the difference into the strength for the spatial filter by using the LUT.

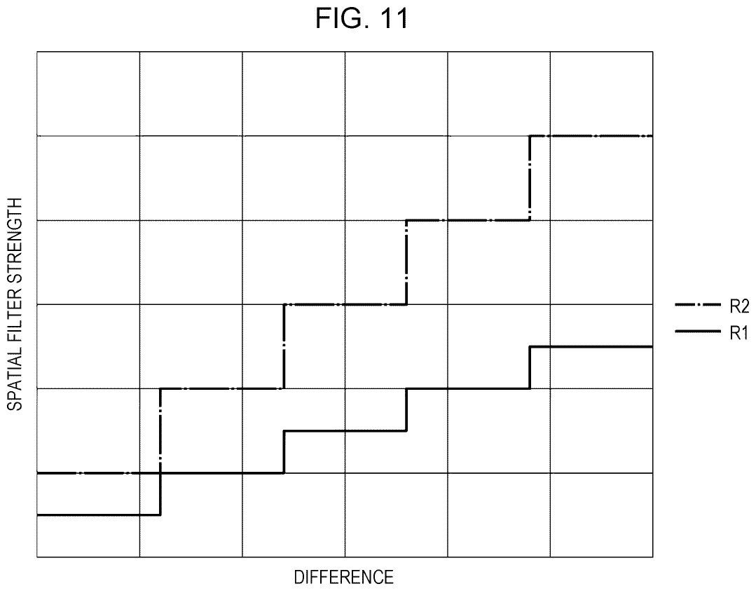

FIG. 11 is a view schematically illustrating a LUT used for the back-side image reader 66 stored in the HDD 190 or the like. In step S212 previously mentioned, the CPU 184 converts the difference into the strength for the spatial filter by using the LUT.

A solid line R1 in FIG. 11 represents the LUT used for the back-side image reader 66. An alternate long and short dash line R2 represents the LUT used for the front-side image reader 42 in FIG. 10 for comparison and reference and is not used actually in this case.

As previously mentioned, the first image reading sensor 82 of the front-side image reader 42 is the reduced optical system, while the second image reading sensor 100 of the back-side image reader 66 is a contact optical system. The second image reading sensor 100 as the contact optical system has a higher contrast transfer function (CTF) than the first image reading sensor 82 as the reduced optical system. Accordingly, a lower strength may be set for the second image reading sensor 100 despite the same difference. As illustrated in FIG. 11, the LUT used for the back-side image reader 66 has a lower strength despite the same difference.

### How to Generate LUT

An example of how to generate a LUT will then be described.

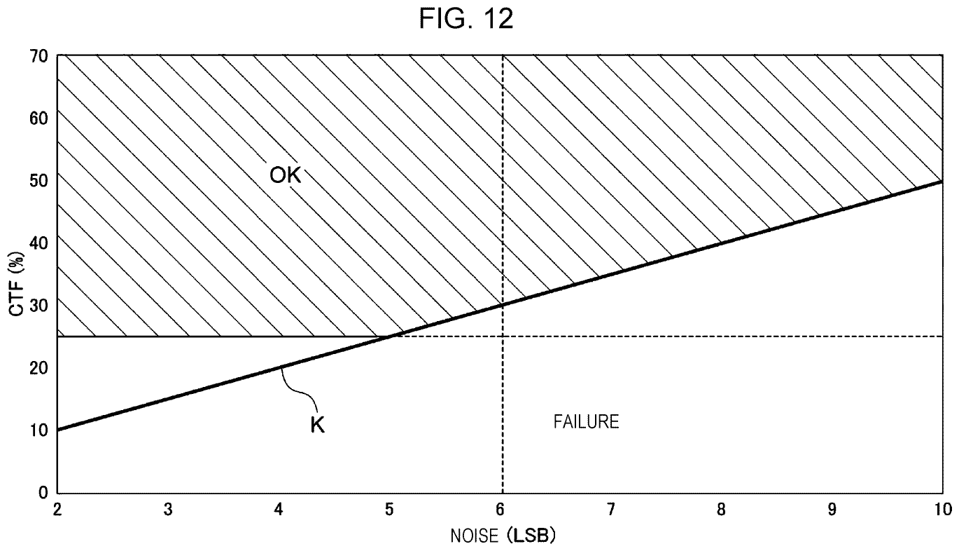

FIG. 12 is a graph schematically illustrating a relationship between noise (a SN ratio) and the CTF. The noise has a value representing the absolute quantity of the noise (SN ratio) because the white reference of the scanner is fixed. The CTF has a value serving as an index for resolving power.

A line K is a line of a border between OK and FAILURE as the result of determination of image qualities of multiple images generated in such a manner as to vary the noise (SN ratio) and the CTF. Since a low CTF causes deterioration of the resolving power of the scanner and thus a rough read image, the CTF requires a value higher than or equal to a given value. In this example, a value of 25% CTF or higher is regarded as OK. A hatched range above the line K and higher than or equal to 25% CTF is the range regarded as OK.

An edge enhancement level in the LUT is set to fall within the hatched OK range in FIG. 12.

### Actions

Actions of this exemplary embodiment will then be described.

If the first light source 72 of the front-side image reader 42 and the second light source 101 of the back-side image reader 66 of the image reader 12 of the image forming apparatus 10 have a reduced amount of light due to deterioration over time, the amount of received light of the first image reading sensor 82 and the second image reading sensor 100 is decreased. The decrease in the amount of received light in the first image reading sensor 82 and the second image reading sensor 100 leads to an increase in the noise ratio of the read image and thus a lower SN ratio, thus deteriorating the image quality of the read image.

However, in the case where the deterioration of the image quality of the read image is reduced in such a manner that the noise ratio is reduced to increase the SN ratio, for example, increasing output of the first light source 72 and the second light source 101 leads to shorter lives of the first light source 72 and the second light source 101. Alternatively, decreasing reading speed and increasing the amount of received light causes lower productivity.

To cope with this, the image reader 12 of the image forming apparatus 10 of this exemplary embodiment performs the following operation. If the amount of light is decreased due to the deterioration over time of the first light source 72 of the front-side image reader 42, and if the difference between the read data resulting from the reading of the first white reference plate 150 and the first reference data exceeds the set value set in advance, the image reader 12 executes the edge enhancement process with the spatial filter on the read image and outputs a processed image.

Likewise, if the amount of light is decreased due to the deterioration over time of the second light source 101 of the back-side image reader 66, and if the difference between the read data resulting from the reading of the second white reference plate 68 and the second reference data exceeds the set value set in advance, the image reader 12 executes the edge enhancement process with the spatial filter on the read image and outputs a processed image.

Image quality deterioration may thus be reduced without executing the process for relatively reducing noise as compared with the case where the read image is output as it is.

In explanation in another point of view, the image quality deterioration is reduced in such a manner that the resolving power is increased by executing the edge enhancement process with the spatial filter to cope with a SN ratio decrease in the read image caused by a decrease in the amount of light due to the deterioration over time of the first light source 72 and the second light source 101.

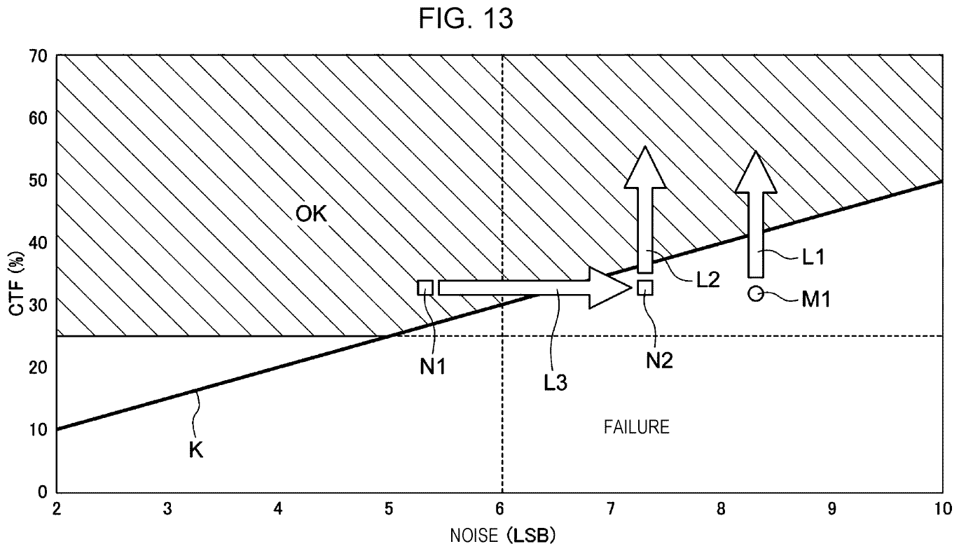

A control method of this exemplary embodiment will then be described by using FIG. 13.

FIG. 13 is a graph in which the explanation of the control method of this exemplary embodiment is added to the graph in FIG. 12 schematically illustrating the relationship between the noise (SN ratio) and the CTF.

A circle M1 and a square N1 in FIG. 13 each represent a state where the decrease in the amount of light due to the deterioration over time of the first light source 72 and the second light source 101 causes a lower SN ratio of the read image and image quality deterioration. Arrows L1 and L2 represent enhancing the image quality by increasing the resolving power in such a manner that the edge enhancement process is executed with the spatial filter. As described above, in the control, the image quality is enhanced by increasing the resolving power in such a manner that the edge enhancement process is executed to cope with the image quality deterioration due to the deterioration over time of the first light source 72 and the second light source 101. A square N2 and an arrow L3 will be described later.

Executing the edge enhancement process with the spatial filter causes noise of the read image to be emphasized in some cases. Hence, in this exemplary embodiment, the emphasized noise is reduced in such a manner that the frequency filtering is performed with the low pass filter on the read image before the edge enhancement process is executed with the spatial filter. That is, the emphasized noise is reduced, and the image quality is improved, as compared with the case where the edge enhancement process is performed with the spatial filter on the read image as it is.

In this exemplary embodiment, if there is a large difference between the first read data and the first reference data or between the second read data and the second reference data, a level for the edge enhancement process for the spatial filter is increased by using the LUT as compared with the case of a small difference. The image quality is improved as compared with the case where the level for the edge enhancement process is fixed.

In this exemplary embodiment, if a level for the edge enhancement process for the spatial filter is high, frequencies for the low pass filter are lowered as compared with the case of a lower level. Noise emphasized due to the edge enhancement process is thus reduced as compared with the case where the frequencies for the low pass filter are fixed.

In this exemplary embodiment, if the difference between the second read data of the back-side image reader 66 that is the contact optical system and the second reference data does not exceed the set value, the output of the second light source 101 is decreased below the rated output until the difference exceeds the set value. The edge enhancement process with the spatial filter is then executed.

As described above, decreasing the output of the second light source 101 below the rated value causes reduction in the deterioration over time of the second light source 101. The deterioration over time of the second light source 101 is thus reduced as compared with the case where the output of the second light source 101 is higher than or equal to the rated value any time. Decreasing the output of the second light source 101 below the rated value causes a decrease in a heating value of the second light source 101, and thus sensitivity deterioration involved with a temperature rise at the second image reading sensor 100 is reduced.

As previously mentioned, the first image reading sensor 82 of the front-side image reader 42 is the reduced optical system, and the second image reading sensor 100 of the back-side image reader 66 is the contact optical system. The second image reading sensor 100 as the contact optical system has a higher CTF than the first image reading sensor 82 as the reduced optical system. The strength may thus be decreased despite the same difference. Accordingly, noise emphasized by the edge enhancement process and by decreasing the output of the second light source 101 of the back-side image reader 66 as the contact optical system is reduced.

In this exemplary embodiment, if the output of the second light source 101 is decreased, the output of the second light source 101 is changed back to the rated value, and the output of the second light source 101 is decreased below the rated output until the difference again exceeds the set value. Accordingly, the output may be decreased in accordance with the deterioration over time of the second light source 101, and thus the image quality deterioration may be reduced as compared with a case where the output of the second light source 101 is maintained at the decreased value.

A control method for decreasing output of the second light source 101 of this exemplary embodiment will then be described by using FIG. 13.

The square N1 in FIG. 13 represents a case where the amount of light from the second light source 101 is sufficient, that is, a state where an image quality having a difference yet to exceed the set value is still in the OK range.

The arrow L3 in FIG. 13 represents a state (the square N2) where the image quality is deteriorated by intentionally decreasing the amount of light from the second light source 101 until the difference exceeds the set value. As previously mentioned, the arrow L2 represents enhancing the image quality by increasing the resolving power in such a manner that the edge enhancement process is executed with the spatial filter. As described above, the control causes the image quality to be enhanced in the following manner. Even if the second light source 101 has not undergone the deterioration over time, the output of the second light source 101 is deliberately decreased to deteriorate the image quality, and the resolving power is increased by executing the edge enhancement process with the spatial filter.

### Others

The present disclosure is not limited to the exemplary embodiment above.

For example, in the exemplary embodiment above, if the difference between the second read data of the back-side image reader 66 and the second reference data does not exceed the set value, the output of the second light source 101 is decreased below the rated output until the difference exceeds the set value, but the disclosure is not limited to this. The output of the second light source 101 may also be used without being changed from the rated output. In addition, if the difference between the first read data of the front-side image reader 42 and the first reference data does not exceed the set value, the output of the first light source 72 may be decreased below the rated output until the difference exceeds the set value.

In the exemplary embodiment above, the present disclosure is applied to the image reader 12 of the image forming apparatus 10 that is a multi-function printer but is not limited to this. The present disclosure may be applied to a standalone image reading device.

Further, various exemplary embodiments may be implemented without departing from the spirit of the present disclosure. Multiple exemplary embodiments, modifications, and the like may be implemented appropriately in combination with each other.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A reading system includes:
a reader that generates a read image by reading reflected light reflected from a target, the reflected light being received by a light receiving part after emitted light emitted from a light source is radiated onto the target; and
a processor configured to:
   receive read data obtained by the reader by reading white reference; and
   in response to a difference between the read data and reference data exceeding a set value set in advance, execute an edge enhancement process with a spatial filter on the read image and output, as a processed image, the read image that has undergone the edge enhancement process.
      (((2)))

In the reading system according to (((1))),
the processor is configured to:
   in response to the difference between the read data and the reference data being large, increase a level for the edge enhancement process for the spatial filter as compared to a case where the difference is small.
      (((3)))

In the reading system according to (((1))) or (((2))),
the processor is configured to:
   perform frequency filtering with a low pass filter on the read image before the edge enhancement process is executed with the spatial filter.
      (((4)))

In the reading system according to any one of (((1))) to (((3))),
the processor is configured to:
   in response to the difference between the read data and the reference data being large, increase the level for the edge enhancement process for the spatial filter and lower a frequency for the low pass filter as compared to a case where the difference is small.
      (((5)))

In the reading system according to any one of (((1))) to (((4))),
the processor is configured to:
   decrease output of the light source below rated output until the difference between the read data and the reference data exceeds the set value.
      (((6)))

In the reading system according to (((5))),
the processor is configured to:
   in response to the light receiving part being a contact optical system, decrease the output of the light source below a rated value.
      (((7)))

In the reading system according to (((5))) or (((6))),
the processor is configured to:
   in response to the output of the light source being lower than a rated output, set the output at the rated output and then decrease the output below a rated value until the difference between the read data and the reference data exceeds the set value.
      (((8)))

A program for a reading system includes a reader and a processor, the reader generating a read image by reading reflected light reflected from a target, the reflected light being received by a light receiving part after emitted light emitted from a light source is radiated onto the target, the program causing the reading system to execute a process including:
receiving read data obtained by the reader by reading white reference; and
in response to a difference between the read data and reference data exceeding a set value set in advance, outputting a processed image resulting from an edge enhancement process executed on the read image with a spatial filter.

What is claimed is:

1. A reading system comprising:
a reader that generates a read image by reading reflected light reflected from a target, the reflected light being received by a light receiving part after emitted light emitted from a light source is radiated onto the target; and
a processor configured to:
receive read data obtained by the reader by reading white reference; and
in response to a difference between the read data and reference data exceeding a set value set in advance, execute an edge enhancement process with a spatial filter on the read image and output, as a processed image, the read image that has undergone the edge enhancement process.

2. The reading system according to claim 1,
wherein the processor is configured to:
in response to the difference between the read data and the reference data being large, increase a level for the edge enhancement process for the spatial filter as compared to a case where the difference is small.

3. The reading system according to claim 1,
wherein the processor is configured to:
perform frequency filtering with a low pass filter on the read image before the edge enhancement process is executed with the spatial filter.

4. The reading system according to claim 3,
wherein the processor is configured to:
in response to the difference between the read data and the reference data being large, increase a level for the edge enhancement process for the spatial filter and lower a frequency for the low pass filter as compared to a case where the difference is small.

5. The reading system according to claim 1,
wherein the processor is configured to:
decrease output of the light source below rated output until the difference between the read data and the reference data exceeds the set value.

6. The reading system according to claim 5,
wherein the processor is configured to:
in response to the light receiving part being a contact optical system, decrease the output of the light source below a rated value.

7. The reading system according to claim 5,
wherein the processor is configured to:
in response to the output of the light source being lower than a rated output, set the output at the rated output and then decrease the output below a rated value until the difference between the read data and the reference data exceeds the set value.

8. A non-transitory computer readable medium storing a program for a reading system including a reader and a processor, the reader generating a read image by reading reflected light reflected from a target, the reflected light being received by a light receiving part after emitted light emitted from a light source is radiated onto the target, the program causing the reading system to execute a process comprising:
receiving read data obtained by the reader by reading white reference; and
in response to a difference between the read data and reference data exceeding a set value set in advance, outputting a processed image resulting from an edge enhancement process executed on the read image with a spatial filter.

9. A reading method for a reading system including a reader and a processor, the reader generating a read image by reading reflected light reflected from a target, the reflected light being received by a light receiving part after emitted light emitted from a light source is radiated onto the target, the method comprising:
receiving read data obtained by the reader by reading white reference; and
in response to a difference between the read data and reference data exceeding a set value set in advance, outputting a processed image resulting from an edge enhancement process executed on the read image with a spatial filter.
